(19) United States
(12) Patent Application Publication
(10) Pub. No.: US 2005/0011816 A1
(43) Pub. Date: Jan. 20, 2005

(54) Self-supporting tray for positioning mail in a mail delivery vehicle

(75) Inventor: Brent W. Zitting, West Valley City, UT (US)

Correspondence Address: FINNEGAN, HENDERSON, FARABOW,;GARRETT & DUNNER, L.L.P., 1300 I Street, NW, Washington, DC, 20005-3315, US

(73) Assignee: UNITED STATES POSTAL SERVICE

(21) Appl. No.: 10/884,926

(22) Filed: Jul. 7, 2004

Related U.S. Application Data
(60) Provisional application No. 60/485,357, filed on Jul. 7, 2003.

(51) Int. Cl. B07C 5/02; G06K 9/00

(52) U.S. Cl. 209/584; 209/900

(57) ABSTRACT

A self-supporting device, which may be adjustably mounted in a mail delivery vehicle having a bracket including two members forming a slot sized to closely fit over an upwardly projecting edge of a mail delivery tray mounted within a mail delivery vehicle. A tray is connected to the bracket. The tray has a horizontal bottom wall and vertical side walls. When the device is mounted on the edge of the mail delivery tray, it can support mail within arms reach of a mail carrier sitting behind the steering wheel of the mail delivery vehicle.

### CROSS REFERENCE TO RELATED APPLICATIONS

Priority under 35 U.S.C. § 119 is claimed based on U.S. Provisional Application No. 60/485,357 filed Jul. 7, 2003, the disclosure of which is expressly incorporated herein by reference.

### BACKGROUND

Technical Field

Embodiments disclosed herein relate to a self-supporting tray for and method of positioning mail within a mail delivery vehicle.

United States Postal Service mail carriers receive bundles of mail for delivery. A bundle is any separately sequenced collection of mail to be delivered. Examples of bundles include 1) delivery-point sequenced mail (“DPS mail”), which has been placed in order of the addresses on the street by automated equipment, 2) flat mail, which is large envelopes or magazines, 3) letters, postcards and smaller mail that is manually put in the delivery sequence by the carrier in the central mail processing facility, 4) full coverage mail, which is usually an advertisement or a political flyer which is intended to be delivered to every address on a route, 5) “marriage mail,” which is a term for advertisements that are inserted into other mail to be delivered such as a newspaper or magazine and 6) parcel post packages.

Each of the bundles is stored for loading and delivery in trays or tubs. These containers are loaded on and under large metal trays in the delivery vehicles. The vehicles used by United States Postal Service carriers include the older “long-life-vehicles” (“LLV”) and the newer “flexible fuel vehicles” (“FFV”). FIG. 1 is a possible arrangement of five bundles, each in a tray or tub (10-18) in a LLV vehicle: trays 10, 12, and 14 are placed on the large metal tray 20, tray 16 is placed on the seat by the driver and tray 18 is placed on the floor of the vehicle. The tray 20 accommodates up to three of the smaller containers. Thus three of the bundles noted above, from which a mail carrier must collect mail for each address, may be stored on tray 20. However, if other bundles exist, while the vehicle physically has room to carry them, they are not easily accessible to the driver, because they are on the floor by the driver's feet or in the driver's lap.

Moreover, the carrier must reach into each container for each bundle to pull any mail that exists in that bundle for the approaching address. This repetitive motion includes stretching and bending depending on how many bundles exist and where the containers storing the bundles are located. Injuries may occur as a result.

One attempted solution used a gap of a few inches between the driver and the edge of tray 20. As illustrated in FIG. 2, in the past, some carriers have attempted to use small tray 25 in the gap to hold a smaller number of pieces of mail to be delivered. This small tray 25 hung off of tray 20 and was held in position by setting one of the bundle containers on top of a flange 27 on tray 25 extending a approximately a quarter of the way along the width of tray 20. Tray 25 could hold any letter-size mail the carrier wished. However, when the mail in the container sitting on top of flange 27 was delivered, the reduced weight might not be enough to keep flange 27 of tray 25 down on tray 20, and small tray 25 would tip or completely fall off of tray 20, spilling everything it contained onto the carrier and parts of the vehicle. Additionally, if a container needed to be moved and a carrier forgot that it was holding down flange 27 of tray 25, the same problem would occur when the carrier picked up the container to move it.

Other drivers reduced the number of times they needed to bend forward by selecting a few pieces of mail from the lower bundles and storing it between their fingers as they drove.

Additionally, mis-sequenced mail may be present in any of the bundles. The vehicle has no pre-planned location for this mail, which must be set aside until that address is next for delivery, or if the address is not on that route, the mail must be returned to the central mail processing facility for inclusion in the proper route.

Finally, carriers collect undeliverable mail out of the bundles as well as out of mailboxes. Examples of undeliverable mail is automatically sequenced mail that is addressed to a person at an address who no longer lives there, but because the mail is not first class, it is not forwarded, or misaddressed mail, i.e., addressed to an address that does not exist. The term “nixie” mail applies to this and anything else that must be returned to the post office for further processing. There is no preplanned location for storing this mail separately in the vehicle, and if it is not separated from the other mail which must be returned, it must be sorted again. This extra sorting interferes with the ability of the carrier to further sort the mail and deliver it in the time required.

An apparatus to store mail within easy reach of the drivers is needed.

### SUMMARY

As embodied and broadly described herein, an embodiment consistent with the invention is an apparatus for holding mail to be delivered. The device includes a bracket having two members forming a slot sized to closely fit over an edge of a mail delivery tray mounted within a mail delivery vehicle. A tray is connected to the bracket. The tray has a bottom wall and side walls. When the apparatus is mounted on the edge of the mail delivery tray, it can support mail within arms reach of a mail carrier sitting behind the steering wheel of the mail delivery vehicle.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate several embodiments consistent with the invention and together with the description, serve to explain the principles of the invention. In the drawings,

FIG. 1 is a side view of the front portion of a vehicle carrying five bundles of mail;

FIG. 2 is a perspective view of a previously used tray;

FIG. 3 is a side view of an embodiment consistent with the invention;

FIG. 4 is a perspective view of the embodiment of FIG. 3;

FIG. 5 is a side view of an embodiment of a bracket consistent with the invention;

FIG. 6 is a top view of the embodiment of the bracket of FIG. 5;

FIG. 7 is a perspective view of an embodiment consistent with the invention including the bracket of FIGS. 5 & 6;

FIG. 8 shows the embodiments of FIGS. 4 and 7 as installed in a vehicle;

FIG. 9 illustrates each of the two above embodiments installed in a vehicle and containing mail; and

FIG. 10 illustrates a carrier selecting mail in the embodiment of FIG. 9.

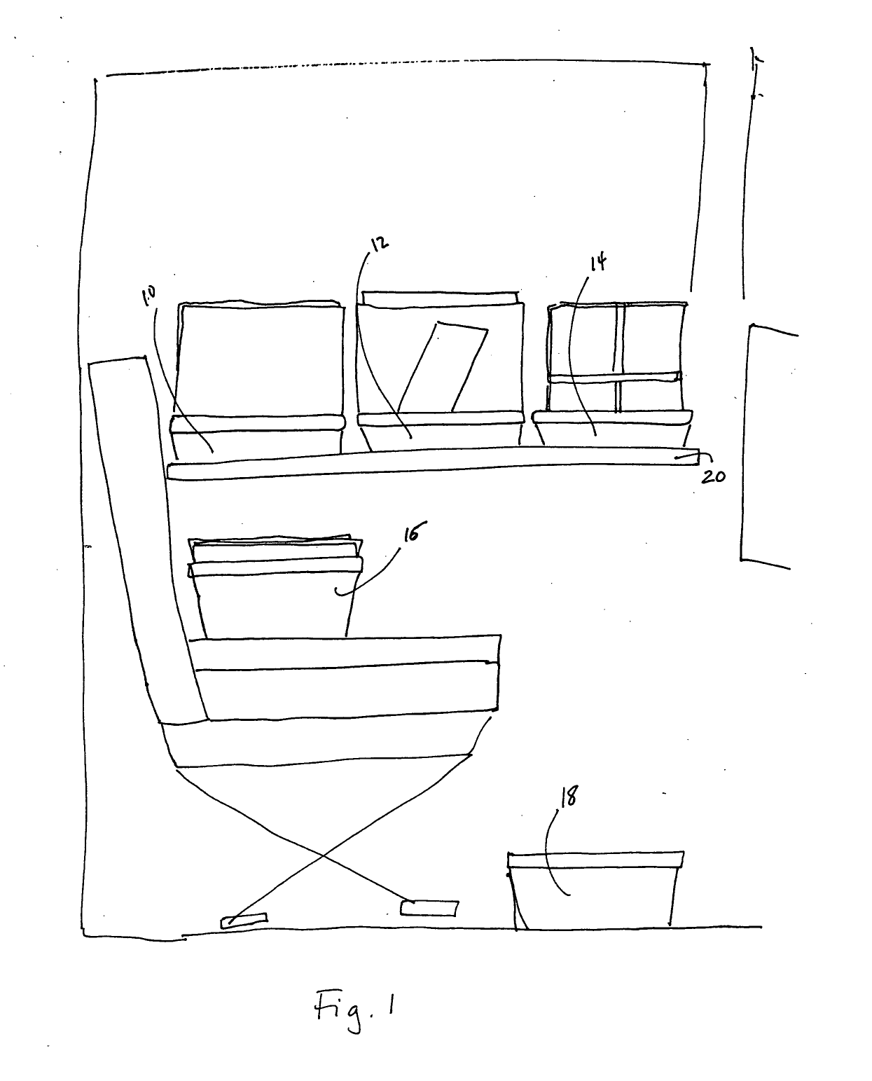

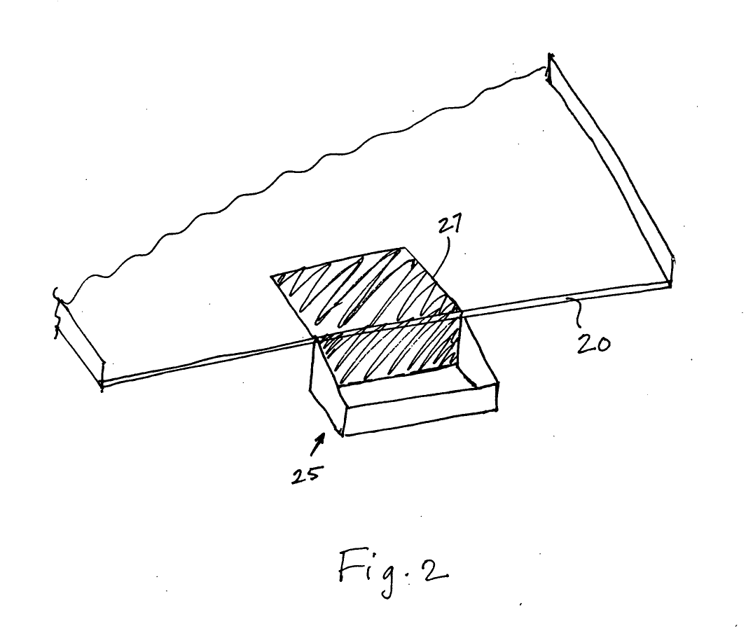

### DESCRIPTION OF EMBODIMENTS

Reference will now be made in detail to the exemplary embodiments consistent with the invention, examples of which are illustrated in the accompanying drawings. Wherever possible, the same reference numbers will be used throughout the drawings to refer to the same or like parts.

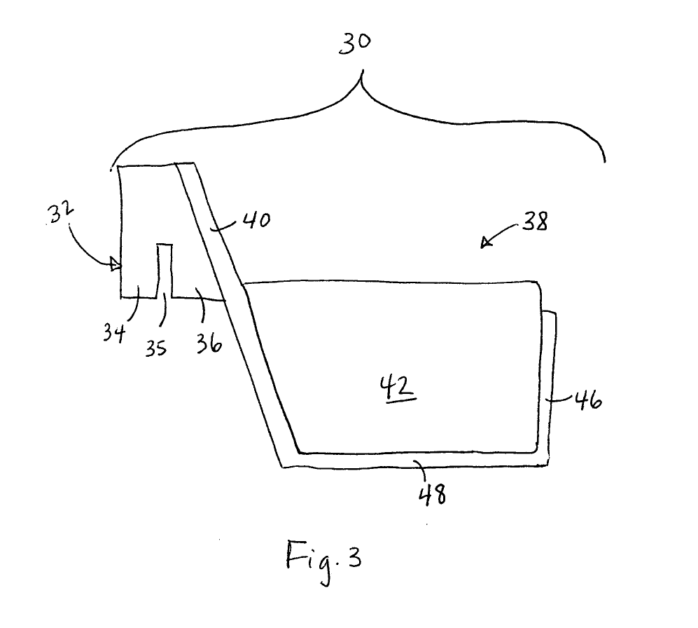

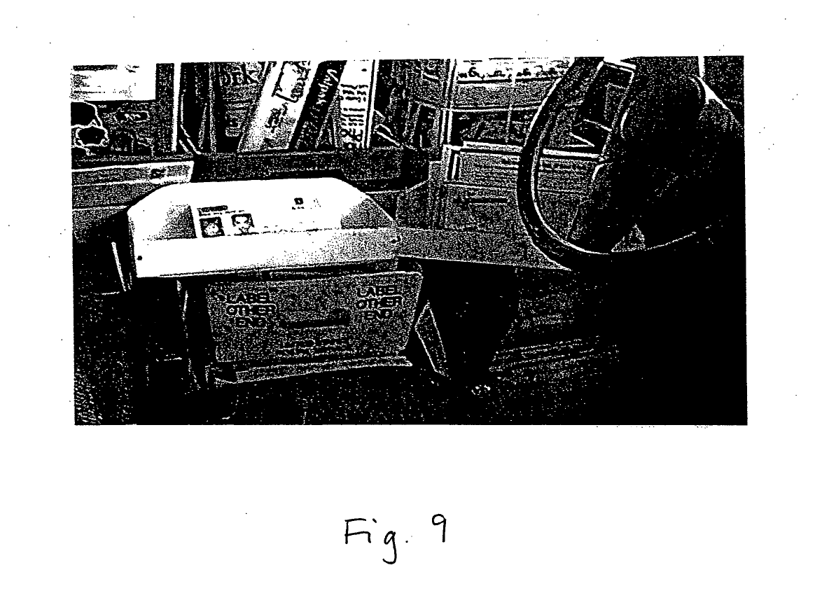

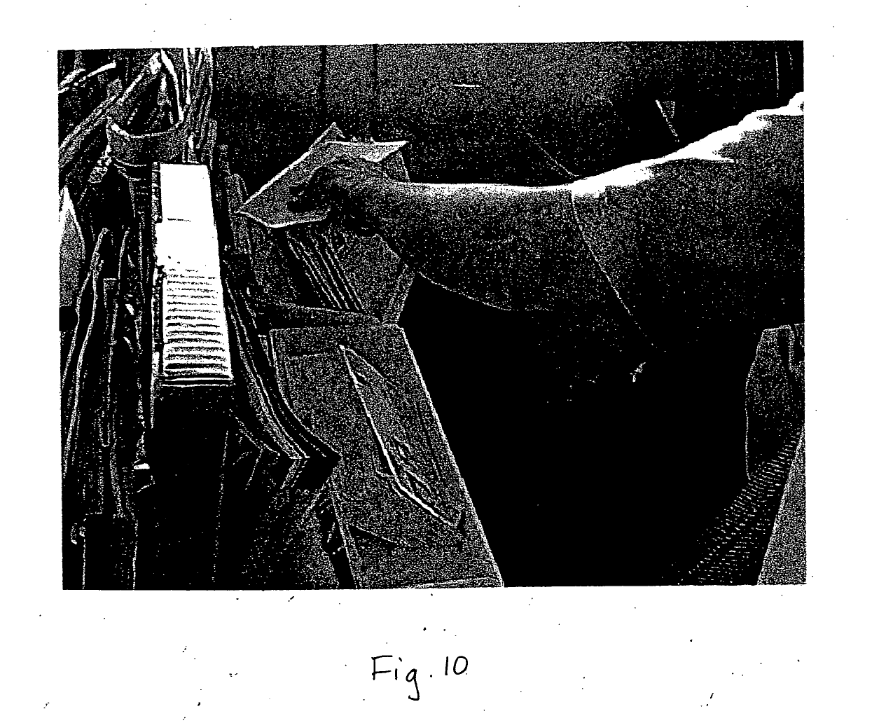

FIG. 3 illustrates a side view of an embodiment consistent with the invention. The device 30 includes bracket 32 and a tray 38. Bracket 32 includes two projections 34 and 36, forming a slot 35 between them that runs the entire length of the bracket. The width of the slot 35 closely approximates the thickness of the edge of a tray 20 on which the device 30 is mounted. As here embodied, the edge of the tray 20 is ⅛ inch wide, and slot 35 is 5/32 inch wide. Thus when mounted on the edge of tray 20, as illustrated in FIG. 9, bracket projections 34 and 36 are very close to the side surfaces of the edge of large metal tray 20 and secure bracket 32 and tray 38 to the edge of tray 20. As here embodied, slot 35 has a depth of ⅝ inches. As here embodied, bracket 32 is constructed of ultra high molecular weight polyethylene (UHMWPE) and tray 38 is constructed of pure vinyl and UHMWPE. FIG. 8, illustrates device 30 mounted in a carrier's delivery vehicle. Thus, as long as the material is strong enough, bracket 32 will be able to support weight in tray 38 without slipping off of tray 20. However, because it is a slip fit over the edge, bracket 32 may be slid forward or backward along the edge of tray 20 by hand to position tray 38 to the carrier's preferred location.

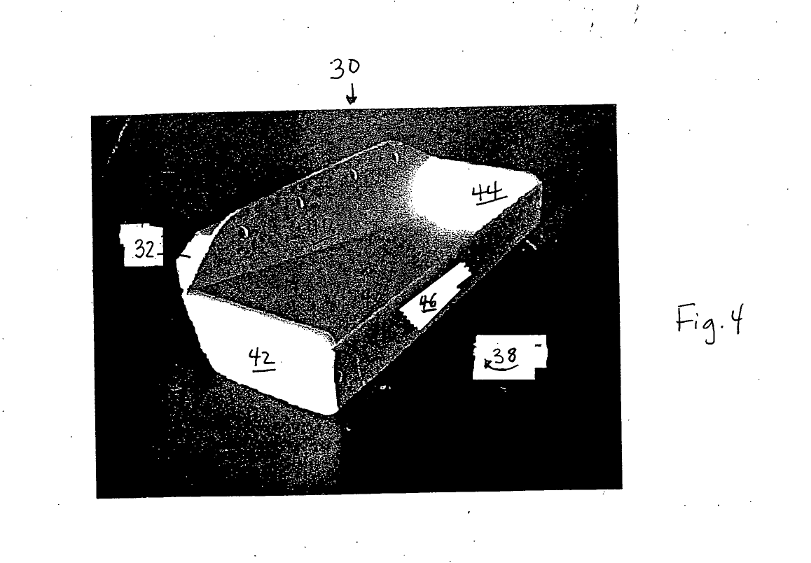

FIG. 4 is a perspective view of device 30. As here embodied, tray 38 has a taller back wall 40 than front wall 46 or side walls 42 and 44, to provide a surface upon which mail stacked in tray 38 may rest at an angle, as illustrated in FIGS. 9 and 10. Back wall 40 forms an angle with bottom wall 48. As here embodied, that angle is approximately 114 degrees (best shown in FIG. 3). Tray 38, as here embodied, has a rectangular bottom wall 48 and is sized to accommodate mail that is at least slightly longer than standard letter envelope size. In this embodiment bottom wall is 13 and ⅝ inches long and 3 and ⅝ inches wide. Back wall 40 is integrally connected to bracket 32, thus tray 38 is non-adjustable with respect to bracket 32. Side walls 42 and 44 are preferably constructed of UHMWPE and bottom wall 48, back wall 40 and front wall 46 are preferably constructed of pure vinyl. Side walls 42 and 44 are trapezoidal in shape to follow the angle formed between back wall 40 and bottom wall 48. Front wall 46, as here embodied is rectangular, 13 and ⅝ inches long and 1 and 13/16 inch high and forms a 90 degree angle with bottom wall 48.

Variations on the relationships between the disclosed components of tray 38 are possible. Specifically, while bottom wall 48 is illustrated as horizontal, it could form an angle with respect to horizontal. The angle may be any value that does not allow the mail stored in the tray to fall out of the tray. While back wall 40 is illustrated as forming an obtuse angle with bottom wall 48, the angle may be perpendicular or even acute as long as the mail stored in the tray does not fall out of the tray. Additionally, the dimensions of the walls may also be varied as long as the resulting combination does not allow the mail stored in the tray to fall out in normal operation.

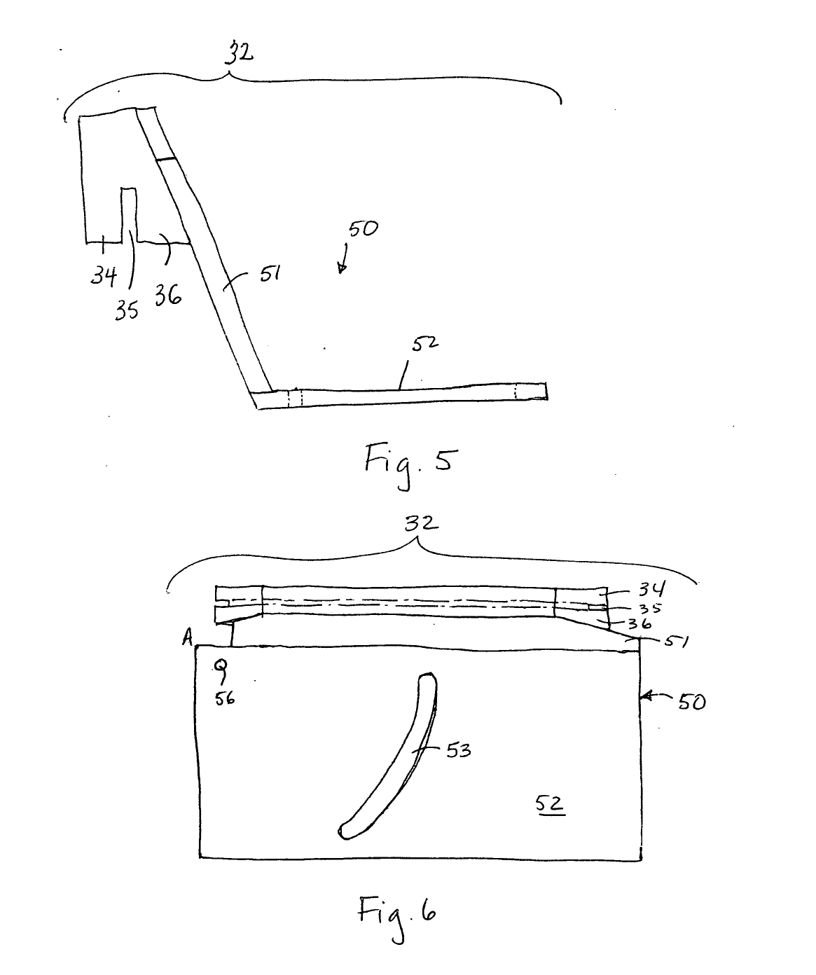

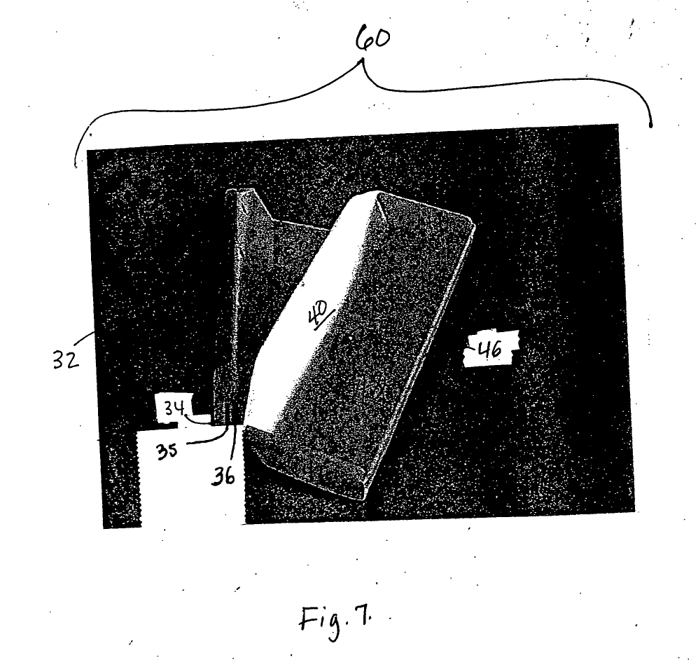

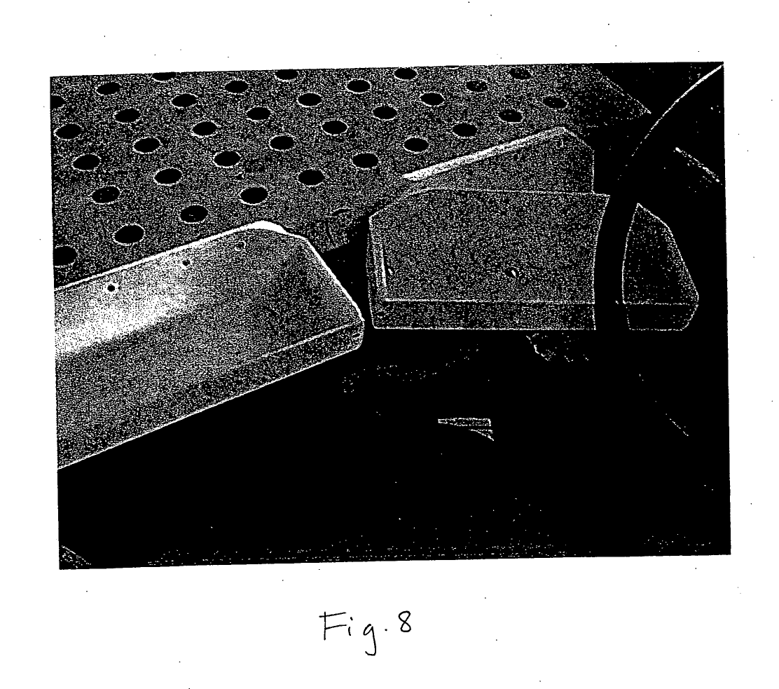

Another embodiment consistent with the invention is illustrated in FIGS. 5-7. In this embodiment, device 60 has an angled portion 50 which includes angled wall 51 and projection 52, which forms an angle, as here embodied, to match the angle on tray 38 between back wall 40 and bottom wall 48. Angled portion 50 is preferably constructed of pure vinyl. Projection 52 includes a hole 56 and a curved slot 53 that provides the ability to pivot tray 38 at an angle with respect to bracket 32 as depicted in FIGS. 7, 8, 9 & 10. Hole 56 is in a corner of projection 52 closest to bracket 32. As here embodied, hole 56 has a center located ½ inch from bracket angled wall 51 and ⅞ inch in from the left edge of projection 52. Slot 53 is ⅜ inch wide and is on a 6⅝ inch radius from the center of hole 56.

In this embodiment tray 38 is not integral with bracket 32, but is connected to projection 52 of bracket 32 by two fasteners. As here embodied tray 38 has two holes for bolts to pass through in order to connect tray 38 and bracket 32. Each hole is sized just greater than the diameter than bolts 54 (shown in FIGS. 7 & 8) and 58 (shown in FIG. 8) to provide a surface on which the bolt head or an associated washer (not shown) can exert a clamping force to adjustably affix tray 38 to bracket 32. The carrier places bracket 32 over the edge of tray 20 and locates it appropriately along the length of that edge. Then he or she loosens the fasteners beneath projection 52 and positions it as desired. Once tray 38 is in the desired position relative to bracket 32, the carrier hand tightens the fasteners. As with the non-adjustable embodiment 30, when mail is stacked in tray 38, the torque generated on bracket 32 does not cause it to pull off of the edge of tray 20.

The invention is used by placing a stack of letter size or smaller mail from a full coverage bundle, such as ADVO notices, in an embodiment of the device. Thus up to five bundles can be within reach of a carrier's arm without having to bend down or at his or her finger tips, rather than in a carrier's lap, between his or her fingers, or stashed on the dashboard or floor of the vehicle. The entire route's worth of full coverage mail may not fit within the portable tray, but the frequency with which a carrier will have to bend and stretch to access the tray or tub with the full coverage mail from that bundle will be greatly reduced. Moreover, the carrier can safely spend attention driving rather than attempting to keep the mail from spilling.

Carriers also use the self-supporting bracket and tray to store mis-sequenced mail that is present in a bundle, until the address is next for delivery. Another use is to place undeliverable mail retrieved from mailboxes along the route or present in a bundle in the tray. The tray maintains it separately from other mail, thus reducing the time required to accurately place it in the proper location upon return to the central mail processing facility at the end of a carrier's route.

Other embodiments consistent with the invention will be apparent to those skilled in the art from consideration of the specification and practice of the invention disclosed herein. It is intended that the specification and examples be considered as exemplary only, with a true scope and spirit of the invention being indicated by the following claims.

1. An apparatus for holding mail to be delivered, comprising:
a bracket including a slot sized to closely fit over an upwardly projecting edge of a mail delivery tray mounted within a mail delivery vehicle; and
a tray connected to the bracket;
wherein the apparatus, when mounted on the edge of the mail delivery tray, can support mail within arms reach of a mail carrier sitting behind the steering wheel of the mail delivery vehicle.

2. The apparatus of claim 1 wherein the tray is adjustably connected to the bracket.

3. The apparatus of claim 1 wherein the bracket may be slid by hand along the edge of the mail delivery tray after mounting.

4. The apparatus of claim 1 wherein the tray comprises a horizontal bottom wall, an angled back wall, and three vertical side walls.
